(19) United States
(12) Patent Application Publication
(10) Pub. No.: US 2025/0343414 A1
(43) Pub. Date: Nov. 6, 2025

(54) Energy Storage System Responsive to Carbon Generation Parameters

(71) Applicant: Cadenza Innovation, Inc., Danbury, CT (US)

(72) Inventors: Maria Christina Lampe-Onnerud, Wilton, CT (US); Tord Per Jens Onnerud, Wilton, CT (US); Richard V. Chamberlain, II, Fairfax Station, VA (US); Bailey Harris, Norwalk, CT (US); Johan Holmberg, Brookville, CT (US)

(73) Assignee: Cadenza Innovation, Inc., Wilton, CT (US)

(21) Appl. No.: 18/871,075

(22) PCT Filed: Jun. 2, 2023
(86) PCT No.: PCT/US2023/024334

§ 371 Date: Dec. 2, 2024

Related U.S. Application Data
(60) Provisional application No. 63/348,539, filed on Jun. 3, 2022.

(51) Int. Cl. H02J 3/00; G06Q 50/06; H01M 10/44; H02J 3/32; H02J 3/38

(52) U.S. Cl. CPC H02J 3/008; G06Q 50/06; H01M 10/44; H02J 3/32; H02J 3/381; H02J 2203/20; H02J 2300/22; H02J 2300/28

(57) ABSTRACT

The present disclosure relates to systems for and methods of using carbon generation parameters with battery energy storage to achieve a desired optimization in the energy storage operation of a battery. At least one parameter in achieving the desired optimization for managing energy storage includes the carbon generation parameter of the energy being used in the battery operations.

### CROSS-REFERENCE TO RELATED APPLICATION

The present application claims priority benefit to a provisional patent application filed with the U.S. Patent Office on Jun. 3, 2022, and assigned Ser. No. 63/348,539. The entire content of the foregoing provisional application is incorporated herein by reference.

### FIELD OF DISCLOSURE

The present disclosure is directed to systems and methods that facilitate managing energy storage operations based, at least in part, on one or more properties of the energy to be accessed/used in storing energy in an energy storage system. In exemplary embodiments, the disclosed systems/methods support selective access to energy source(s) that satisfy one or more specified carbon generation-related properties. The disclosed systems/methods provide, inter alia, a further tool for promoting and supporting energy generation operations that minimize carbon generation, thereby advancing ongoing efforts to address climate change challenges.

### BACKGROUND

Energy storage systems based on rechargeable batteries are receiving ever more attention for the purpose of modernizing the electrical grid, e.g., battery systems that are connected to an electrical grid and that store and/or deliver energy based, at least in part, on a Battery Energy Storage System (BESS). A number of functions, such as demand charge reduction (also referred to as peak shaving), time of use adjustments, and participation in scheduled demand response programs, increase energy efficiency and help to manage and respond to energy demand fluctuations. In many cases, energy sources for energy storage are relatively CO₂-free. Common examples include solar, wind, hydro and other power generating sources that do not rely on fossil fuels. Even fossil fuel sources can be better utilized in energy storage systems, e.g., energy storage systems that are based, in whole or in part, on battery storage.

Battery energy storage systems can take various forms, e.g., rechargeable batteries or mechanically charged batteries, such as flow batteries, pumped hydro, and compressed air energy storage. Rechargeable batteries include Li-ion batteries, which can be of liquid and polymer type or solid-state battery types. Besides Li-ion, many other types of rechargeable batteries exist. The disclosed systems and methods are applicable to this full range of rechargeable/mechanically charged batteries. Although Li-ion batteries are used in the examples described herein, the present disclosure is not limited to any particular type of energy storage function. The word “battery” as used herein refers to all devices for energy storage function that enable delivery of electrical energy.

The battery functions of a conventional BESS include a diverse range of operational modes that can be delivered quickly, or during longer periods of time, to and from the electrical grid. These operational modes always affect the battery so that the battery is either discharged or charged, as the BESS responds to monitoring functions or remote instructions. A BESS is installed either behind-the-meter (BTM) or in-front-of-the-meter (FTM). Sometimes, through software control delivered by a combination of software at the battery and software that resides in servers that are cloud connected through the internet, these batteries can be steered simultaneously in a virtual power plant (VPP) to obtain the desired effect on a power grid or a commercial and industrial (C&I) or residential site.

A VPP consists of multiple batteries installed behind one meter or as a number of batteries installed in front of the meter that together deliver a desired combined effect on the grid in a geographical area. When multiple batteries are deployed, it is common that a utility provider contracts with an aggregator that delivers so-called demand response signals to the installed batteries, based on signals from the utility. The utility or a battery owner can also directly control the multiple batteries. A number of publications from the National Renewable Energy Laboratory (NREL) and other organizations describe these battery systems and how they are typically deployed.

Typical functions seen in BESS include demand charge reduction (also referred to as peak shaving), demand response functionality, time-of-use functions, frequency regulation and backup power. For BTM batteries, energy management software is used that controls the battery charge and discharge modes to allow cost effective utilization of low-cost energy. Through the software, a BESS can react to an outside signal from an aggregator that requires a demand response function, which delivers a reduction of power to a grid point during a certain time frame. Alternatively, still through software, a BESS can react to a power meter that allows the battery to lower the apparent power that is monitored through a smart meter, which is an operational tool resulting in lowered demand charges. Yet another method is to store the energy when a local solar system (connected behind the meter) or the grid itself has lower cost energy than other high-cost periods and dispatch this power in another “time-of-use.” This lowers the cost of energy and allows for a more effective use of solar energy or shifting the use of the solar energy from a period of low cost to a period of high cost. Similarly, a BESS can be charged by the grid during a low cost period and discharged during a high cost period.

A typical BESS consists of a DC battery that has a number of cells connected in series and parallel. This DC battery is then connected to an inverter system that converts DC current to an AC current suitable for the grid, allowing the battery to discharge. Likewise, the inverter can take AC power from the grid and convert to DC power that can charge the battery. The inverter is generally designed to detect irregularities in the grid or absence of the grid, which allows the backup function to be enacted. The inverter can also match the power characteristics, voltage and frequency, of a grid so that the BESS can be connected without any disruptions to the grid or damaging inrush currents to the BESS.

Current transformers (CTs) or other power monitoring devices can communicate power levels to the BESS for monitoring incoming power, information which is typically used when a demand charge reduction is desired as a function of detected power. Peak reduction can also be implemented by time functions when the loads are known. For sites such as telecom sites, where there is a relative abundance of DC loads, the DC loads can be peak shaved and a similar response of demand charge reduction can be obtained through a rectifier as when utilizing an inverter.

Unless the BESS is part of an isolated microgrid, a BESS owned by a non-utility owner is typically installed behind a utility meter (see FIG. 1A). The BESS monitors the power behind this one meter and optimizes charge/discharge functionalities based on economic metrics. Targeting these metrics allows for monitoring the cost of power from the grid, which lowers demand charges or responds towards a demand response period by redistributing the energy, thereby lowering the electrical cost or generating revenue.

When a utility customer allows a demand response action to deliver power to the grid point, a net decrease of power allows the utility to indirectly manage the general load of the grid during certain time periods. This in turn can optimize the utilization of electrical energy generating systems so that a sufficient amount of energy can be delivered without the risk of overload that can cause the electrical grid to fail. Similar methods are used to optimize the usage of renewable energy sources for effective deployment of electrical energy to the grid.

When a customer's renewable energy source responds to a demand called from the utility, an economic incentive is obtained by the customer.

Monitoring functions that interact with the battery systems can detect the power level generated by loads behind the meter and deploy the battery so that the maximum power to the site over a tariff period is lowered. Such demand reduction lowers cost for customers that are charged in a tariff based on the maximum power used by the site. In yet other scenarios, the battery can be used to shift the timing of the energy used, so that a high use period or high generation period, such as a wind burst or intense solar period, can use the energy stored in the battery for discharge or charge at a later time. This type of action, i.e., optimizing use of lower cost periods in a tariff, is referred to as time of use and allows economic rewards for customers that have electrical tariffs that change based on the time of day. These functions are in addition to any backup power value. Some battery systems are designed to respond to when the grid is erratic or down. All of these functionalities are referred to as value streams for the battery.

In the United States and other countries, the energy in an electric grid is generated from a number of wholesale power generators, which can be derived from a combination of fossil fuels and renewable energy sources. In the U.S., the common electric grid is in part managed by independent system operators (ISOs) or regional transmission organizations that manage the transmission of electric energy within a region. Other countries have similar structures. The ISO system was created out of the Federal Energy Regulatory Commission as a transmission operator of a larger region and provides non-discriminatory access to the electrical grid. An ISO region has multiple transmission line owners and multiple energy generators that feed the common grid with electric power. The power transmission lines are typically owned by local electric utility companies, who sometimes own one or more electrical generation facilities. These facilities can run on fossil fuel or generate electrical energy from renewable energy resources.

Depending on the energy mix at any point in time, the grid may have a relatively high amount of renewable energy compared to fossil fuel based energy or vice versa. There is significant variation in this mix over time, depending on solar and wind conditions. With an increased number of solar and wind farms, this variation will continue and potentially become even more uneven. While fossil fuels today generate most of the available electrical energy, renewable energy sources are becoming more and more prevalent as a global power source as global warming is addressed. In order to track and allow for transparency about the energy mix received by customers, ISO organizations and providers of electrical energy provide customers with real time data using telemetry signals that describe certain characteristics of the grid power. This telemetry, which is often delivered in real time, shows data such as total power levels, amount of fossil vs. renewable energy, price of energy at any given time, and other important metrics such as “carbon intensity”. Telemetry metrics, financial and other, for the power mix of a grid can be used to trade energy in real-time.

With the modern grid, energy can be bought by providers, if desired, from only renewable sources or any desired mix that provides optimized cost. These energy trading algorithms may be computerized/automated or managed by individuals. Customers can contract with providers of electrical energy and buy energy at different price levels, using either a standardized monthly tariff rate structure or rates that vary with the natural price variation of the electrical grid. Pricing varies widely and depends on factors such as type of energy source and natural supply and demand variation. Low periods of electrical use can be extremely low cost, while high periods of use can have temporary price spikes that are many multiples of a baseline cost of a standard tariff from a utility.

Many providers of energy and ISOs also provide telemetry with the energy delivered, which allows transparency to what type of energy and what price the customer pays for the electrical energy. Typically, C&I and residential customers choose to buy their energy from a provider that has a stable tariff, which often includes time-of-use or demand charge variations. However, for many years, financial markets and owners of battery banks have been trading on the so-called retail market, allowing batteries to be charged during low-cost periods and battery-stored energy to be sold during high-cost periods, delivering net income to the owner of the battery bank.

With the options described above, a commercial and industrial (C&I) or residential customer can purchase its electrical energy from a utility that manages both the generation and transmission. Alternatively, the customer has a choice to buy energy generated by a provider with higher renewable content than the utility, while still using the same utility transmission lines.

Another type of customer is one that benefits from energy storage associated with a battery, either by owning and controlling the battery or being the beneficiary of the battery's actions, e.g., through a service agreement with a third party. In a deregulated region, a customer can buy its energy directly from any available provider of electrical energy and contract transmission of this energy from the utility that is local to the customer and owns the transmission lines. The energy provider in turn can source its energy from one or more energy generators and sell this energy mix to the customer. Although these scenarios use the same transmission lines, the customer has a choice to buy energy from a provider with high renewable content or to simply buy the standard mix that a utility provides. These customer decisions are primarily driven by the cost of the energy to be supplied.

### SUMMARY

The methods and systems of the present disclosure advantageously provide a customer with an ability to source its energy using an algorithm that optimizes its purchase based on criteria that can include not only traditional financial metrics related to a tariff or spot price, but also based on the carbon intensity of a grid at a relevant point in time. The financial metric is typically measured in cost per kW or cost per kWh. Carbon intensity is a metric that relates to a mass of CO₂ per kWh of energy at any particular point in time, g/kWh. Carbon intensity can also be reported as grams per kilowatt at a given point in time. The carbon intensity metric is used to determine the State of Carbon in a battery. The State of Carbon is a separate and distinct metric from the typical State of Charge that is measured in a battery.

In one embodiment, batteries utilizing the disclosed systems and methods can store energy (by charging the battery) when carbon intensity is low (on a relative basis) and release the energy to a site or to the grid when carbon intensity is high (on a relative basis) by discharging the battery. In another embodiment, a battery utilizing the disclosed systems and methods can optimize the energy operation of the battery based on carbon intensity and financial metrics. In yet another embodiment, a battery utilizing the disclosed systems and methods customizes energy management in a battery by using two or more metrics, wherein at least one of the metrics is carbon intensity.

The present method and systems are optimally tied to wholesale energy sources, allowing for easy control and transaction measures, including the use of blockchain technology. While the systems and methods disclosed herein may also be connected to a utility, it is possible that consumers will receive a less favorable mix of electrons that makes minimizing carbon generation less favorable than being tied to wholesale energy markets. The systems and methods disclosed herein, whether tied to wholesale energy suppliers, a utility provider, or other energy source, provide unique and unexpected systems and methods of managing energy storage operations.

The disclosed systems and methods operate in a counterintuitive manner relative to traditional battery use, as the carbon intensity metric does not always follow a desired financial optimization. However, by use of the innovative systems and methods, the customer can decide whether to optimize its energy purchase based on optimizing carbon intensity instead of optimizing based on financial metrics alone, and can implement an optimization regimen that prioritizes optimization of carbon intensity in the customer's energy usage patterns.

Thus, the disclosed systems and methods allow for and facilitate optimizing battery usage actions based on carbon intensity, financial, and other metrics, which deliver a net lowered carbon intensity of energy used, while lowering the cost to a site. By tracking the energy stored in the battery to its carbon intensity through a carbon indicator gauge (further described below), various modes of operation can be deployed that allow a customer to customize its carbon footprint relative to financial metrics. Examples include operational modes such as providing demand charge reduction using lower carbon intensity energy from a battery as compared to the average grid; using artificial intelligence and/or traditional algorithms to optimize cost and carbon intensity simultaneously; and charge the battery through a meter that is optimizing charging based on carbon intensity metrics and discharging to site loads behind a second meter.

In exemplary implementations of the present disclosure, a battery system is provided that includes a processor that is programmed with an algorithm that utilizes a carbon intensity metric received from one or more energy sources to make a decision to charge or discharge, wherein the algorithmic decision to charge or discharge is based at least in part on a carbon intensity metric. The disclosed algorithm may include or operate based upon both a financial metric and the carbon intensity metric. The algorithm allows a user to set a ratio between the financial metric and the carbon intensity metric.

In exemplary embodiments, the carbon intensity metric may be recorded as carbon credit in a ledger.

In exemplary embodiments, the decision to charge or discharge is based on an average battery life total of the carbon intensity metric. The decision to charge or discharge may also be based on an average of the carbon intensity metric over a regular period of time.

The disclosed algorithm may be optimized based on a lowest cost metric with a lowest carbon intensity metric. The algorithm may further include or operate based on battery life metrics.

The disclosed battery system may include a first meter and a second meter, wherein the battery system can be charged and discharged from the first meter and affect a second meter with behind the meter charge and discharge. An energy provider of the first meter may be different from the energy provider of the second meter.

The disclosed battery system may include an indicator that displays the carbon intensity metric. The indicator may display a comparison of the carbon intensity metric of one or more batteries in the system to the carbon intensity metric of an electric grid. The indicator may display a weight of carbon in the battery system.

The disclosed algorithm may use artificial intelligence to optimize the carbon intensity metric.

The carbon credit may be recorded using block chain technology.

The present disclosure also provides a method of operating a battery system that includes:
(i) providing a battery system that is capable of charging and discharging energy;
(ii) providing at least one energy source that is connected to the battery system, wherein the at least one energy source has a carbon intensity metric; (iii) providing an algorithm that analyzes the carbon intensity metric of the energy source; and (iv) utilizing the algorithm to make a decision to charge or discharge the battery system.

The algorithm used in the disclosed method may include and/or operate based on both a financial metric and the carbon intensity metric. The algorithm may allow a user to set a ratio between the financial metric and the carbon intensity metric.

The disclosed method may further include recording the carbon intensity metric as a carbon credit in a ledger. The carbon credit may be recorded using block chain technology.

The disclosed algorithm may calculate an average of the carbon intensity metric over a total life of the battery system. The disclosed algorithm may calculate an average of the carbon intensity metric over a regular period of time. The disclosed algorithm may include and/or operate based on battery life metrics. The algorithm may use artificial intelligence to optimize the carbon intensity metric. The algorithm may analyze the carbon intensity metric in real-time.

The present disclosure further provides a battery system, wherein the battery system includes at least one lithium ion battery and a State of Carbon gauge.

Additional features, functions and benefits of the disclosed systems and methods will be apparent from the detailed description which follows, particularly when read in conjunction with the appended figures.

### BRIEF DESCRIPTION OF THE FIGURES

To assist those of skill in the art in practicing the subject matter of the present application, reference is made to the accompanying figures wherein:

FIG. 1A is a schematic drawing showing exemplary architecture of a traditional BESS installed behind a meter.

FIG. 1B is a schematic drawing showing exemplary architecture of a BESS wherein the BESS is installed behind one utility meter M2 for charging the battery, while providing an ability to discharge energy behind a second utility meter M1, in which E1 is energy provider 1 and E2 is energy provider 2.

FIG. 2 is a flow chart showing an exemplary decision-making matrix according to the present disclosure.

FIG. 3 is an second flow chart showing an further exemplary decision-making matrix according to the present disclosure

### DESCRIPTION OF EXEMPLARY EMBODIMENTS

The disclosed systems and methods use carbon generation parameters with battery energy storage to achieve a desired optimization in the energy storage operation of a battery. At least one parameter in achieving the desired optimization for managing energy storage includes the carbon generation parameter of the energy being used in the battery operations.

A key to the disclosed systems/methods is a leveraging of and responsiveness to carbon intensity, whether with or without other telemetry, such as financial metrics. Of note, the modes of operation of the disclosed systems and methods are different from a traditional supply of renewable energy during off-solar or off-wind periods in time, from a battery that has been charged by a local renewable energy plant installed next to the battery. By using algorithm(s) that simultaneously monitor the carbon intensity on the grid (or relevant segment of an energy sourcing environment) and taking into the account financial metrics of a tariff or from retail markets, a battery utilizing the innovative systems and methods can not only optimize the traditional financial value streams available to a battery, but also positively affect the carbon footprint for a customer.

Systems and methods according to the present disclosure advantageously allow for charge and discharge decisions of a battery based on grid telemetry for (a) carbon intensity, (b) utility tariffs and/or retail market variation, and (c) other battery metrics. Telemetry from local solar or wind grids (or any other renewable energy source), as well as the telemetry of a grid having a financial metric and carbon intensity metric at a particular point in time is recorded by an energy management system. The energy management software, either through a specific algorithm or through Artificial Intelligence-implemented decision-making, then make a decision to charge or discharge the BESS depending on the carbon intensity metric, optionally in combination with the financial metric.

One potential operative parameter and benefit according to the present disclosure involves optimizing energy usage based on only a carbon intensity metric. This can be contrasted with traditional use of a BESS with conventional functionalities, which allows for optimizing energy usage based on only financial metrics. Various optimization priorities can be set with the disclosed systems and methods, such as always optimizing the carbon intensity metric first and as a second priority, optimizing the financial metrics, only when allowed by the carbon intensity metric. Yet another algorithm may have a threshold financial metric that has to be reached first, and within that metric the carbon intensity is optimized by the algorithm. The disclosed algorithm may thus be used to optimize carbon intensity and financial metrics within a billing cycle or within another period for the carbon intensity metric. Of note, the billing cycle may be different from the carbon intensity period. For example, the period may be the lifetime of the battery or any period that differs from the standard billing cycle.

In one aspect, the disclosed systems and methods provide a customer with lowest energy cost and combine this metric with functionalities that allow the customer to further optimize its purchase based on carbon intensity goals or any other metric that essentially indicates the amount of CO₂ predominant in the energy mix purchased from one or more electrical energy providers.

Common to functionalities associated with the present disclosure and implemented thereby is the use of a BESS that temporarily stores a desired energy mix and then uses this energy mix to provide energy to a site of use behind-the-meter (BTM), thereby simultaneously optimizing cost of energy and reducing carbon intensity. The battery can be used to effectively lower the carbon intensity to a site. This allows the customer to achieve an even higher level of control over the financial and carbon intensity mix compared to that provided by the energy provider or, if desired, optimize on carbon intensity while sacrificing some of the economic benefits.

In order for the system to decide whether to charge or discharge a BESS that is optimizing the net effect of both financial metrics and a carbon intensity metric, a carbon gauge or indicator tool is generally provided. The carbon gauge is a measure of how much CO2 resides in the energy that is available in the battery. If the battery is completely discharged, the gauge is “0” or “0%” of total energy. This gauge displays the State of Carbon, wherein the State of Carbon is as outlined below.

The State of Carbon can be characterized and reported as a percentage of total carbon that can be stored should the battery be charged by renewable energy only, or a measure of weight of carbon (or its CO₂ equivalent) for the available stored battery energy in kWh, the battery's nameplate capacity. State of Carbon can be created in a variety of ways, such as in a way that is meaningful to the customer and allows a determination whether to charge or discharge the battery based on the telemetry of the incoming energy as it pertains to at least a carbon intensity metric. Financial metrics can also be used in conjunction with the carbon intensity metric in the determination of whether to charge or discharge the battery.

For example, the disclosed State of Carbon can operate such that if a battery is filled to 100% with non-renewable energy, this carbon gauge could be at one extreme, e.g., 100%. If the battery is filled by renewable power only, such as solar, the gauge would be at another extreme, e.g., 0%. The 0% would be prevalent for any amount of renewable energy that resides in the battery. However, with a fossil fuel energy source, a 100% reading would only apply when the battery is fully charged by fossil fuel, while a 50% filled battery would have a 50% measure. If such a battery is filled to 100% with renewable energy after being 50% filled with fossil fuel, the carbon gauge stays at 50%. However, for the former case, if a system at a nominal energy, say 100 kWh, is 50% charged from 100% fossil fuel, the carbon gauge would be 50% for the 100 kWh. For the 100% charged battery, the carbon gauge remains at 50% because it was only 50% filled from fossil fuel. The carbon gauge thus relates a certain amount of CO₂ or its relative mixture based on the total energy in the battery and the relative carbon intensity upon the electrical energy used when the battery was fueled.

In another example, the weight of carbon (g or kg) represented by the stored energy is assessed in the gauge or indicator as the battery is charged or discharged. This weight of carbon can be compared to a favorable measure or an unfavorable measure based on the general carbon intensity of a common grid.

The carbon intensity metric can be used to track a customer's improvement to its carbon footprint, to enable compliance with corporate carbon goals, and/or to lower carbon consumption due to relevant laws, such as recently implemented Local Law 97 in the State of New York (USA). In such cases, a penalty fee can be avoided due to laws and regulations that penalize a site owner for excessive use of CO₂ or for failing to lower its carbon footprint within a required time frame.

The State of Carbon gauge allows average carbon sourced from a grid to be compared to that of discrete levels of carbon stored in a battery at any point in time and is therefore an essential metric that enables a decision whether to charge or discharge a battery depending on the carbon intensity metric of the grid and operational parameters set by the user.

The State of Carbon gauge associated with the present disclosure will be both accurate and immutable and therefore auditable through various accounting methodologies, including but not limited to block chain technology. The State of Carbon or carbon intensity metric is recorded in a ledger or accounting system as carbon credit. The carbon credit can be traded or used for other purposes after being recorded. This allows for mitigation techniques to combat the climate crisis, create carbon offsets, and create new market opportunities in carbon trading.

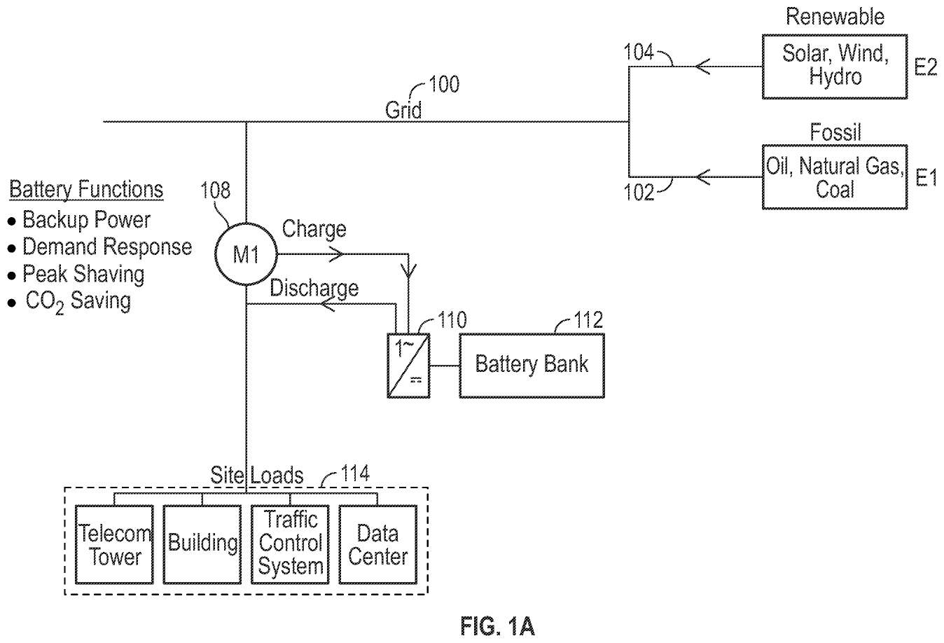

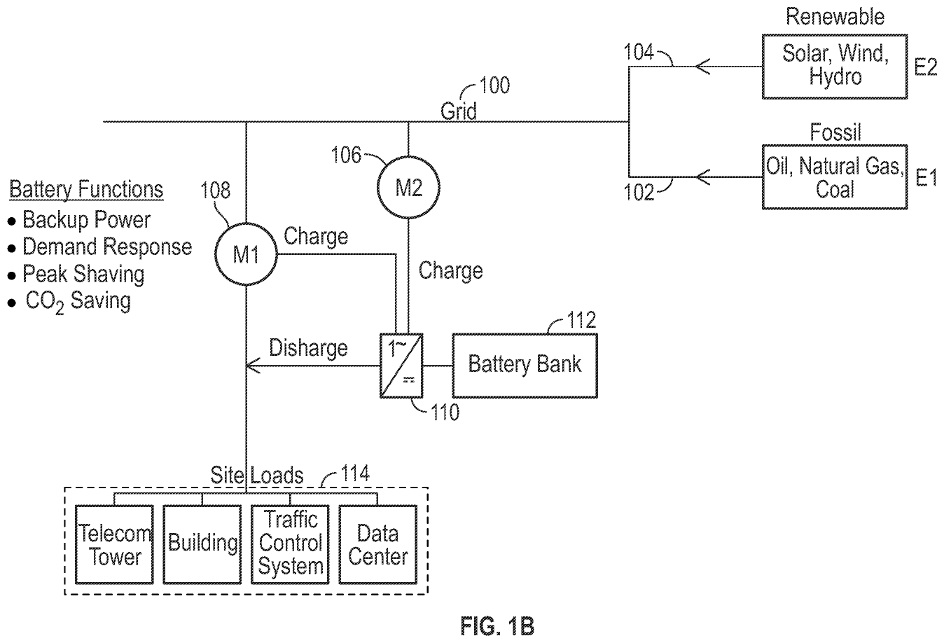

Novel systems that provide for the innovative features utilizing the carbon intensity metric can either be installed traditionally BTM (FIG. 1A) or using a second meter (FIG. 1B), where the BESS is charged through an optimized charging function, and discharged to loads behind a second meter. In this case, the second meter has a different energy mix than the first meter. For systems that have a local renewable energy source in a micro grid, further mixing of the purchasing functions for charging the BESS can be beneficial. The first energy meter may have a different energy provider than the second energy meter.

With initial reference to FIG. 1A, grid 100 is fed with two distinct classes of energy: E1 energy (102) is based on fossil fuel(s) (e.g., oil, natural gas, coal) and E2 energy (104) is based on renewable energy source(s) (e.g., solar, wind, hydro). The mixture of energy on the grid may vary from time-to-time. M1 meter (108) meters energy from grid 100 to charge battery 110/battery bank 112. The battery/battery bank may serve various functions, e.g., backup power, demand response, peak shaving and CO₂ saving. Energy discharged from battery 110/battery bank 112 may be used for various site loads 114 (e.g., telecom tower, building, traffic control system, data center, etc.)

With reference to FIG. 1B, as was the case in FIG. 1A, grid 100 is fed with two distinct classes of energy: E1 energy (102) is based on fossil fuel(s) (e.g., oil, natural gas, coal) and E2 energy (104) is based on renewable energy source(s) (e.g., solar, wind, hydro). The mixture of energy on the grid may vary from time-to-time. M2 meter (106) meters renewable energy that is used to charge battery 110/battery bank 112, whereas M1 meter (108) meters fossil fuel energy that is used to charge battery 110/battery bank 112. The battery/battery bank may serve various functions, e.g., backup power, demand response, peak shaving and CO₂ saving. Energy discharged from battery 110/battery bank 112 may be used for various site loads 114 (e.g., telecom tower, building, traffic control system, data center, etc.).

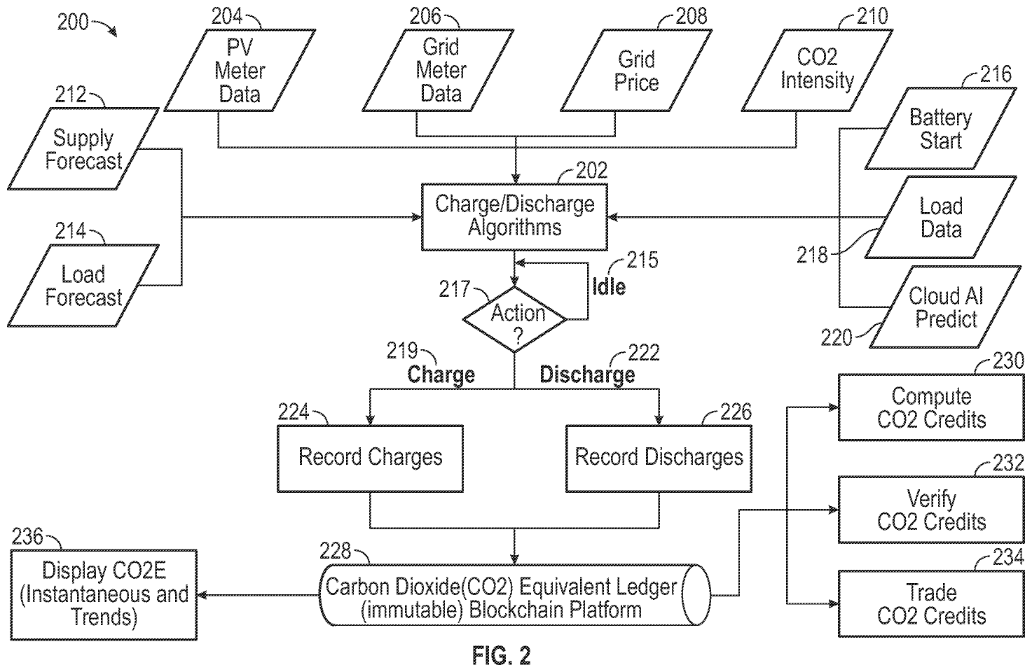

With reference to FIG. 2, flowchart 200 shows an exemplary decision-making matrix according to the present disclosure. Various data elements may be fed into charge/discharge algorithm(s) 202 that operates on a processor, including PV meter data 204, grid meter data 206, grid price 208 and CO₂ intensity 210. Additional data elements that may be fed to charge/discharge algorithm 202 include supply forecast data 212 and load forecast data 214, as well as battery start data 216, load data 218 and AI predictive input 220, e.g., from the Cloud. Based on data input, the charge/discharge algorithm assesses the relative benefits of charging and/or discharging based on applicable criteria.

The decision-making matrix associated with flowchart 200 may assume a rest/inactive/idle state 215 between charge/discharge actions. Based on determinations by the charge/discharge algorithm 202, an action 217 may be prompted/initiated, e.g., a charge action 219 or a discharge action 222. The system/method records “charges” (224) and “discharges” (226), and such actions may be entered into a ledger 228, e.g., a carbon dioxide equivalent ledger that may be immutably recorded in a blockchain platform.

Based on the charge/discharge decision-making driven by the charge/discharge algorithm 202, the disclosed system/method generally yields beneficial carbon-related performance. The carbon performance may be used to compute CO₂ credits at step 230 (e.g., credits from government/regulatory authorities), verify CO₂ credits at step 232 and facilitate trading of CO₂ credits at step 234. The system may also display CO₂ performance data at step 236, e.g., instantaneous performance and/or trend-related performance.

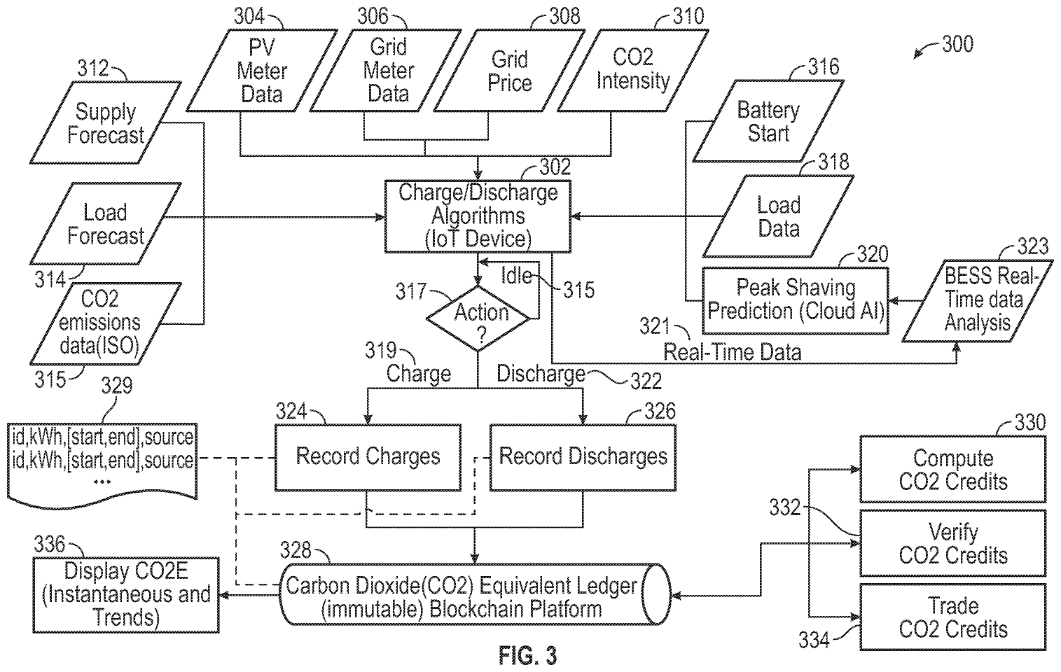

Turning to FIG. 3, flowchart 300 shows an alternative exemplary decision-making matrix according to the present disclosure. As with flowchart 200, various data elements may be fed into charge/discharge algorithm(s) 302 that operates on a processor, including PV meter data 304, grid meter data 306, grid price 308 and CO₂ intensity 310. Additional data elements that may be fed to charge/discharge algorithm 302 include supply forecast data 312, load forecast data 314 and CO₂ emissions data 315 (e.g. from ISO), as well as battery start data 316, load data 318 and peak shaving prediction input 320, e.g., from a Cloud AI program. Of note, the peak shaving prediction input 320 may receive and incorporate real-time data 321 that is fed through a BESS real-time data analysis functionality 323. Based on data input, the charge/discharge algorithm assesses the relative benefits of charging and/or discharging based on applicable criteria.

The decision-making matrix associated with flowchart 300 may assume a rest/inactive/idle state 315 between charge/discharge actions. Based on determinations by the charge/discharge algorithm 302, an action 317 may be prompted/initiated, e.g., a charge action 319 or a discharge action 322. The system/method records “charges” (324) and “discharges” (326), and such actions may be entered into a ledger 328, e.g., a carbon dioxide equivalent ledger that may be immutably recorded in a blockchain platform, e.g., in the general format shown in box 329.

Based on the charge/discharge decision-making driven by the charge/discharge algorithm 302, the disclosed system/method generally yields beneficial carbon-related performance. The carbon performance may be used to compute CO₂ credits at step 330 (e.g., credits from government/regulatory authorities), verify CO₂ credits at step 332 and facilitate trading of CO₂ credits at step 334. The system may also display CO₂ performance data at step 336, e.g., instantaneous performance and/or trend-related performance.

According to an embodiment of the present disclosure, a battery energy management system and method are provided that include a gauge or indicator adapted to run an algorithm that controls the charge and discharge behavior of the associated battery (or batteries) so that a carbon intensity metric and State of Carbon in the battery system can be optimized to achieve a desired goal. Furthermore, the energy cost can be optimized with carbon intensity in mind.

The disclosed systems and methods may operate to maintain a real-time reading of the State of Carbon gauge associated with the battery (or batteries) subject to control by the energy management system. While measuring the State of Carbon, the system may maintain a real-time reading of the amount of energy stored on the battery (or batteries), subject to control by the energy management system. Furthermore, while measuring the state of carbon, the system may maintain a real-time reading of the amount of additional energy that might be stored on the battery (or batteries) subject to control by the energy management system (i.e., unused storage capacity).

In an embodiment, the battery system can access real-time (or as-available) carbon intensity metrics for energy available for purchase/download from the energy grid (or grids) from which the energy management system may purchase/download energy to its battery (or batteries). The battery system may additionally access real-time (or as-available) pricing metrics for energy available for purchase/download from the energy grid (or grids) from which the energy management system may elect to purchase/download energy to its battery (or batteries).

In an embodiment, while measuring the State of Carbon, the battery system may calculate applicable pricing metrics based on unique customer contracts or arrangements that influence the pricing metrics specific to a particular energy management system.

Based on criteria established in the algorithm for energy decision-making by the energy management system, energy may be downloaded from the grid to the battery (or batteries) when such criteria for download are satisfied. These criteria include a carbon intensity metric for energy available for download from the grid at the relevant point in time and potentially financial metrics associated with the same energy available for download from the grid at the relevant point in time. The weighting of the carbon intensity metrics relative to the financial metrics (as compared to reference criteria for each) and potentially other criteria may be considered in the algorithm that the disclosed energy management system uses to make an energy download determination.

Based on criteria established in the algorithm for energy decision-making by the energy management system, energy may be uploaded to the grid from the battery (or batteries) (or otherwise utilized) when such criteria for upload (or utilization) are satisfied. These criteria include a carbon intensity metric for energy available on the grid at the relevant point in time and potentially financial metrics associated with same energy available on the grid at the relevant point in time. The weighting of the carbon intensity metrics relative to the financial metrics (as compared to reference criteria for each) and potentially other criteria may be considered in the algorithm that the disclosed energy management system uses to make an energy upload determination.

In an embodiment, the carbon intensity can be used and/or measured by the disclosed systems and methods in conjunction with thermal storage in addition to battery storage

In another embodiment, artificial intelligence (AI) is used to refine the decision-making for upload and/or download of energy to or from the battery (or batteries) associated with the energy management system. The algorithm for determining whether to charge or discharge a battery or batteries within a system may include user input, artificial intelligence, or a combination thereof.

In yet another embodiment, the system provides reports based on operation of the energy management system, including reports that reflect a carbon intensity metric of the energy downloaded to and/or uploaded by the battery (or batteries), financial metrics of energy downloaded to and/or uploaded by the battery (or batteries), and/or comparisons of carbon intensity and/or financial metrics relative to energy utilization independent of the energy management system (i.e., as compared to control conditions).

The disclosed energy management system and methods may be adapted to allow a user to prioritize financial and carbon metrics with a settable ratio of priority between the two metrics. The foregoing ratio may be varied from time-to-time by the user, or in response to measured conditions.

The disclosed energy system may be adapted to optimize energy-related actions based on various criteria, e.g., based on carbon metrics over a total battery life and/or based on regular period, e.g., monthly, to achieve lowered cost with lowest carbon.

The measurement and reporting functionalities associated with the disclosed energy management systems and methods may include, inter alia, an ability to capture/record the carbon intensity metric as carbon credits.

Artificial intelligence can be used by the disclosed systems and methods to enhance the algorithmic functionality so as to further optimize battery charge and discharge. Examples of using AI when optimizing carbon intensity, with or without financial optimization, includes machine learning based on geographic, seasonal, time-of-day, historic and evolving practices of energy generators and distributors, battery capacity, battery chemistry and the like. A range of AI-related methods may be implemented according to the present disclosure.

Although the present disclosure has been provided with reference to exemplary embodiments and/or implementations, the present disclosure is not limited by or to such exemplary embodiments/implementations. Rather, modifications, refinements and enhancements may be made without departing from the spirit or scope of the present disclosure, as will be apparent to persons of skill in the art based on the disclosure provided herein.

1. A battery system comprising a processor that is programmed with an algorithm that utilizes a carbon intensity metric received from one or more energy sources to make a decision to charge or discharge, wherein the algorithmic decision to charge or discharge is based at least in part on a carbon intensity metric.

2. The battery system of claim 1, wherein the algorithm comprises both a financial metric and the carbon intensity metric.

3. The battery system of claim 2, wherein the algorithm allows a user to set a ratio between the financial metric and the carbon intensity metric.

4. The battery system of claim 1, wherein the carbon intensity metric is recorded as carbon credit in a ledger.

5. The battery system of claim 1, wherein the decision to charge or discharge is based on an average battery life total of the carbon intensity metric.

6. The battery system of claim 1, wherein the decision to charge or discharge is based on an average of the carbon intensity metric over a regular period of time.

7. The battery system of claim 1, wherein the algorithm is optimized based on a lowest cost metric with a lowest carbon intensity metric.

8. The battery system of claim 1, wherein the algorithm further comprises battery life metrics.

9. The battery system of claim 1, wherein the battery system comprises a first meter and a second meter, wherein the battery system can be charged and discharged from the first meter and affect a second meter with behind the meter charge and discharge.

10. The battery system of claim 9, wherein an energy provider of the first meter is different from the energy provider of the second meter.

11. The battery system of claim 1, wherein the battery system comprises an indicator that displays the carbon intensity metric.

12. The battery system of claim 11, wherein the indicator displays a comparison of the carbon intensity metric of one or more batteries in the system to the carbon intensity metric of an electric grid.

13. The battery system of claim 11, wherein the indicator displays a weight of carbon in the battery system.

14. A battery system of claim 1, wherein the algorithm uses artificial intelligence to optimize the carbon intensity metric.

15. A battery system according to claim 4, wherein the carbon credit is recorded using block chain technology.

16. A battery system according to claim 1, wherein the decision to charge or discharge is recorded.

17. A battery system according to claim 16, wherein the recordation is based on block chain technology.

18. A method of operating a battery system comprising:
providing a battery system that is capable of charging and discharging energy;
providing at least one energy source that is connected to the battery system, wherein the at least one energy source has a carbon intensity metric;
providing an algorithm that analyzes the carbon intensity metric of the energy source; and
utilizing the algorithm to make a decision to charge or discharge the battery system.

19. The method of claim 18, wherein the algorithm comprises both a financial metric and the carbon intensity metric.

20. The method of claim 18, wherein the algorithm allows a user to set a ratio between the financial metric and the carbon intensity metric.

21. (canceled)

22. (canceled)

23. (canceled)

24. (canceled)

25. (canceled)

26. (canceled)

27. (canceled)

28. (canceled)

29. (canceled)

30. (canceled)
